(19) United States
(12) Patent Application Publication
(10) Pub. No.: US 2005/0050118 A1
(43) Pub. Date: Mar. 3, 2005

(54) Method and system of managing files in intelligent network attached storage

(75) Inventor: Kun-Ta Tsai, Shi Chi City (TW)

Correspondence Address: WELSH & KATZ, LTD, 120 S RIVERSIDE PLAZA, 22ND FLOOR, CHICAGO, IL, 60606, US

(73) Assignee: ICP Electronics, Inc., Shi Chi City (TW)

(21) Appl. No.: 10/783,622

(22) Filed: Feb. 20, 2004

(30) Foreign Application Priority Data
Sep. 3, 2003 (TW) 92124387

(51) Int. Cl. G06F 17/30

(52) U.S. Cl. 707/206

(57) ABSTRACT

An intelligent file management system has a storage unit, a file directory unit, a file detective unit and a file filter unit. The storage unit has all kinds of hard discs and optical discs. The file directory unit is employed to record and control the status of the storage unit. The file detective unit serves to detect content changes in the file directory unit and simultaneously send a message regarding changes to the file filter unit. The file filter unit decides whether a file is allowed to be saved or not according to the message and management criteria. In addition, the file filter unit can control storage capacity of the intelligent network attached storage (NAS) by deleting unnecessary files.

### BACKGROUND OF THE INVENTION

1. Field of Invention

The present invention relates to a file management method and system. More particularly, the present invention relates to a file management method and system in which a file filter is employed to manage network attached storage.

2. Description of Related Art

As information and data grow explosively, enterprises have begun to use a cost-effective storage and method to manage huge amounts of data. Network Attached Storage (hereafter, NAS) has been developed because of this kind of demand.

Conventional NAS can be accessed at any time by a computer with capability of connection to the Internet. However, the amount of data is so huge that NAS capacity quickly runs out. The reason why NAS capacity may run out quickly is described as follows: 1. The storage system can't reject trash files; for example, a system can't tell which files are temporary files or backup files such that it can't reject them. 2. When storage system capacity runs out, the trash files have to be deleted manually. 3. Life span of a file is not managed; the file still occupies storage capacity after its expiration date.

### SUMMARY OF THE INVENTION

It is therefore an objective of the present invention to provide an intelligent file management method and system so as to manage the network attached storage more effectively.

In accordance with the foregoing and other objectives of the present invention, an intelligent file management system includes a storage unit, a file directory unit, a file detective unit and a file filter unit. The storage unit includes all kinds of hard disk drives and rewritable optical discs. The file directory unit coupled to the storage unit is employed to record and control the status of the storage unit via a file allocation table in the file directory unit. The file detective unit coupled to the file directory unit serves to detect content changes or new files in the file directory unit and simultaneously send a message regarding changes to the file filter unit. The update status of the file directory unit is therefore known and controllable. The file filter unit decides whether a file is allowed to be saved or not according to the message and management criteria. The file filter is also coupled to the file directory unit, file detective file and storage unit, respectively. In addition, the file filter unit can control storage capacity of the intelligent network attached storage (NAS) by deleting unnecessary files.

According to one preferred embodiment of present invention, the file detective unit detects a processing signal of the file data while the file data is being written in the storage unit. The processing signal is sent to a file filter so as to control the writing status of the file data. The file filter receives the processing signal, and handles the processing signal according to the management criteria of the file filter so as to decide whether the file data should be written in the storage unit or not. The file filter keeps on detecting the processing signal and recording writing and reading procedures of the file data so as to manage the file data. The management criteria of the file filter can be an expiration date (or life span) of the file data such that the file data will be deleted after the expiration date. The management criteria of the file filter can also be a capacity limit. When the storage unit is under the capacity limit, file data with expired life spans are deleted. Moreover, the management criteria of the file filter can be file categories. The file filter decides whether the file data should be written or not according to file name extensions.

According to another preferred embodiment of present invention, a file detective unit detects a processing signal of the file data while the file data is being amended in a storage unit. The processing signal is sent to a file filter so as to control the amending status of the file data. The file filter receives the processing signal, and handles the processing signal according to the management criteria of the file filter so as to decide whether the file data should be written in the storage unit or not. The management criteria of the file filter can be an expiration date (or life span) of the file data such that the file data will be deleted after the expiration date. The management criteria of the file filter can also be a capacity limit. When the storage unit is under the capacity limit, file data with expired life spans are deleted. Moreover, the management criteria of the file filter can be file categories. The file filter decides whether the file data should be written or not according to file name extensions.

According to preferred embodiments of present invention, the intelligent file management method and system not only reject unnecessary files in the network storage, but also periodically clean out file data with expired life spans. Therefore, the present invention can reduce investments in expanding storage capacity.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a block diagram of an intelligent file management system according to one preferred embodiment of this invention;

FIG. 2 illustrates a flow chart of how to manage writing a file according to one preferred embodiment of this invention; and

FIG. 3 illustrates a flow chart of how to manage amending a file according to one preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In order to manage an NAS capacity effectively, the present invention provides an intelligent NAS file management method and system to meet demands and reduce investments in expending storage capacity. Preferred embodiments and drawings are used to describe this invention.

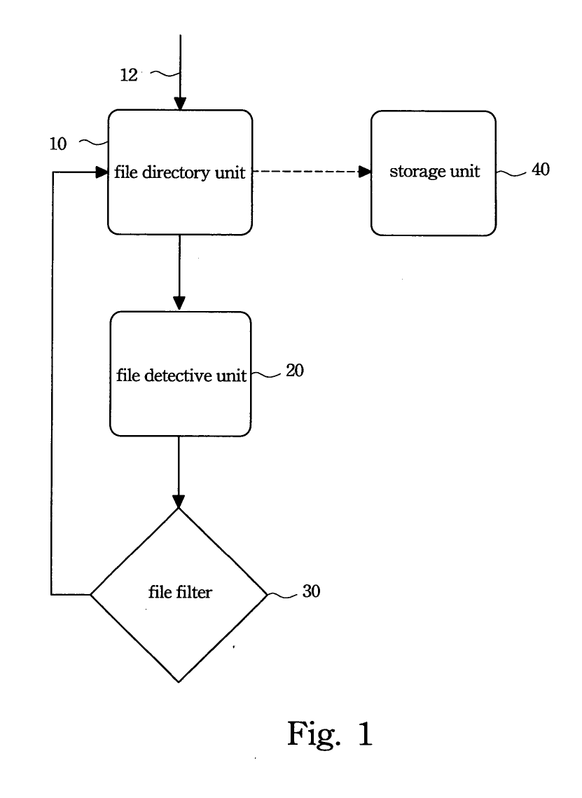

FIG. 1 illustrates a block diagram of an intelligent file management system according to one preferred embodiment of this invention. The intelligent file management system includes a file directory unit 10, a file detective unit 20, a file filter 30 and a storage unit 40. The file directory unit 10 coupled to the storage unit is a kind of File Allocation Table (hereafter, FAT), positioned in a beginning session of floppy disks or hard disk drives. Its function is to manage and record file data information in the storage unit 40, such as floppy disks, hard disk drives or rewritable optical discs.

The FAT file directory unit keeps evolving in various kinds of operating system, such as Windows 98, Windows 2000, Linux, UNIX or the like. Thus, the file directory unit is employed to receive writing/amending processing signal 12. There are various kinds of file directory units, such as FAT 16, FAT 32 and NTFS.

File detective unit 20 and file filter unit 30 are programs operating in a computer. The file detective unit 20, coupled to the file directory unit 10, detects a processing signal of amending a file or writing a new file from the file directory unit 10. The file filter 30, receiving the processing signal from the file detective unit 20, decides whether a file should be executed (written or amended) or not according to the criteria of the file filter 30, so as to manage the reading or writing procedures of the file. The storage unit 40, such as hard disk drives (HDD), redundant array of independent disks (RAID), random access memory and non-volatile memory (NVM), is employed to store file data.

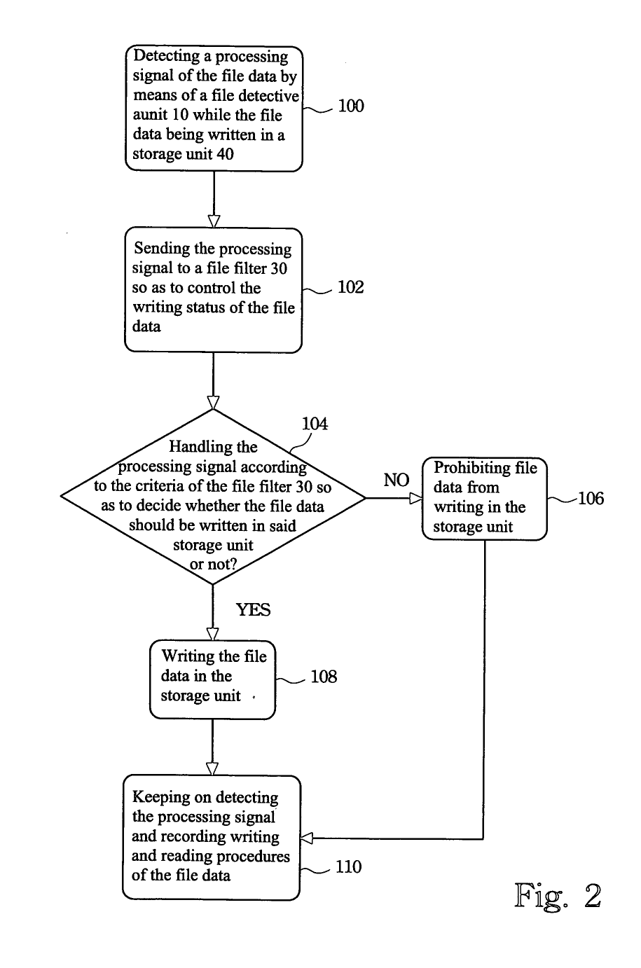

FIG. 2 illustrates a flow chart of how to manage writing a file according to one preferred embodiment of this invention. Step 100 detects a processing signal of the file data by means of a file detective unit 20 while the file data is being written in a storage unit 40. Next, step 102 sends the processing signal to a file filter 30 so as to control the writing status of the file data. The file filter 30 receives the processing signal, and executes step 104, where the processing signal is handled according to the criteria of the file filter 30 so as to decide whether the file data should be written in the storage unit or not. The criteria of the file filter 30 can be an expiration date (or life span) of the file data such that the file data will be deleted after the expiration date. The criteria of the file filter 30 can also be a capacity limit. When the storage unit 40 is under the capacity limit, file data with expired life spans are deleted. For example, the file data with expired life spans in the storage unit 40 are deleted when the file filter detect that the storage unit 40 capacity is lower than 20%.

Moreover, the criteria of the file filter 30 can be file categories. The file filter 30 decides whether the file data should be written or not according to file name extensions. For example, if some backup's file name extensions are *.bak or *.tmp, users may prohibit this kinds of files from being written into the storage unit 40. The file filter can reject temporary file and trash mail from writing in the storage unit 40. When the processing signal matches any of the criteria mentioned above, step 106, “prohibiting file data from writing in the storage unit” is executed and then step 110, “continuing to detect the processing signal and recording writing and reading procedures of the file data” is executed. However, if the processing signal doesn't match any of the criteria, step 108, “writing the file data in the storage unit” is executed and then step 110, “continuing to detect the processing signal and recording writing and reading procedures of the file data” is executed.

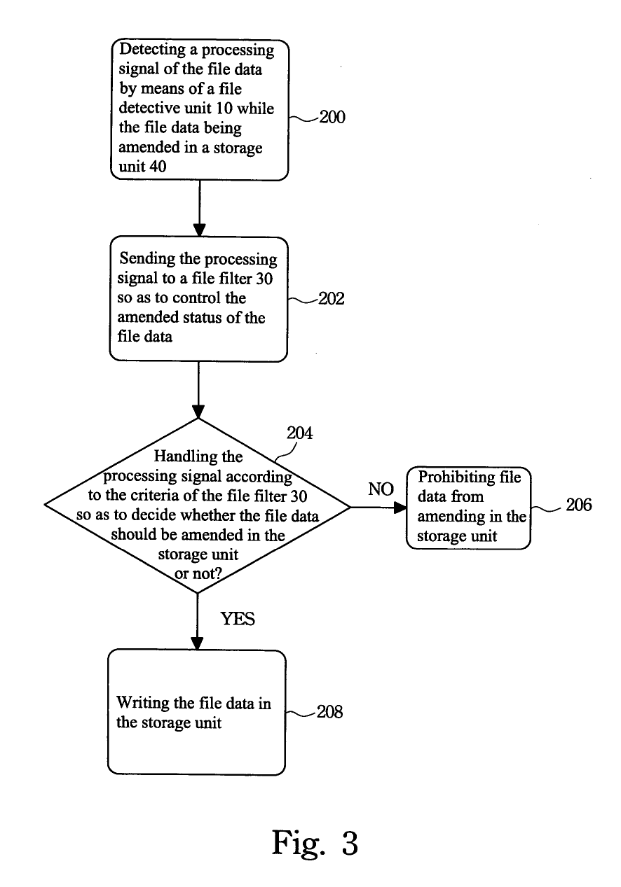

FIG. 3 illustrates a flow chart of how to manage amending a file according to one preferred embodiment of this invention. Step 200 detects a processing signal of the file data by means of a file detective unit 10 while the file data is being amended in a storage unit 40. Next, step 202 sends the processing signal to a file filter 30 to control the amended status of the file data. The file filter 30 receives the processing signal, and in step 204, the processing signal is handled according to the criteria of the file filter 30 so as to decide whether the file data should be amended in the storage unit or not.

The criteria of the file filter 30 can also be a capacity limit. When the storage unit 40 is under the capacity limit, the file data with expired life spans are deleted. For example, the file data with expired life spans in the storage unit 40 will be deleted when the file filter detects that the storage unit 40 capacity is lower than 20%.

Moreover, the criteria of the file filter 30 can be file categories. The file filter 30 decides whether the file data should be written or not according to file name extensions. For example, if some backup's file name extensions are *.bak or *.tmp, users may prohibit this kinds of files from being written into the storage unit 40. The file filter can reject temporary file and trash mail from writing in the storage unit 40. When the processing signal fits in with any of the criteria mentioned above, step 206, “prohibiting file data from being amended in the storage unit” will be executed. However, if the processing signal doesn't fit in with any of the criteria, step 208, “writing the file data in the storage unit” will be executed.

According to preferred embodiments of present invention, the intelligent NAS file management method and system not only reject unnecessary files, but also periodically clean out file data expired life spans. Therefore, present invention can reduce investments in expanding storage capacity.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A file management system, employed to control a storage capacity of an intelligent network attached storage, said system comprising:
a storage unit, storing file data;
a file directory unit, coupled to said storage unit, said file directory unit recording and controlling the status of said storage unit by managing the addresses of said file data;
a file detective unit, coupled to said file directory unit, said file detective unit detecting and changing a processing signal of said file data or detecting and adding said processing signal of said file data;
a file filter unit, respectively coupled to said storage unit, said file directory unit, and said file detective unit, said file filter unit receiving said processing signal from said file detective unit, wherein said file filter unit handles said processing signal according to criteria of said file filter so as to control reading and writing status of said storage unit.

2. The file management system of claim 1, wherein said criteria comprise an expiration date to delete said file data after the expiration date.

3. The file management system of claim 1, wherein said criteria comprise a capacity limit to delete said file data when said storage unit is under the capacity limit.

4. The file management system of claim 1, wherein said criteria comprise file categories so as to decide whether said file data should be written or not according to file name extensions.

5. The file management system of claim 4, wherein said file categories are selected from a group consisting of temporary files, trash mails and a combination thereof.

6. The file management system of claim 1, wherein said storage unit is selected from a group consisting of floppy disks, hard disk drives, redundant array of independent disks, random access memory, non-volatile memory, rewritable optical discs and combinations thereof.

7. The file management system of claim 1, wherein said file detective unit further comprises detecting a processing signal of adding a new file data so as to control the writing status of said file data.

8. A file management method, employed to control a storage capacity of an intelligent network attached storage, said method comprising the steps of:
detecting a processing signal of file data by means of a file detective unit data while said file data is being written in a storage unit;
sending said processing signal to a file filter so as to control the writing status of said file data;
receiving said processing signal by means of said file filter, handling said processing signal according to the criteria of said file filter so as to decide whether said file data should be written in said storage unit or not; and
continuing to detect said processing signal by means of said file filter and recording writing and reading procedures of said file data so as to manage said file data.

9. The file management method of claim 8, wherein said criteria comprise an expiration date to delete said file data after the expiration date.

10. The file management method of claim 8, wherein said criteria comprise a capacity limit to delete said file data when said storage unit is under the capacity limit.

11. The file management method of claim 8, wherein said criteria comprise file categories so as to decide whether said file data should be written or not according to file name extensions.

12. The file management method of claim 11, wherein said file categories are selected from a group consisting of temporary files, trash mails and a combination thereof.

13. The file management method of claim 8, wherein said storage unit is selected from a group consisting of floppy disks, hard disk drives, redundant array of independent disks, random access memory, non-volatile memory, rewritable optical discs and combinations thereof.

14. A file management method, comprising:
detecting a processing signal of file data by means of a file detective unit data while said file data being amended in a storage unit;
sending said processing signal to a file filter so as to control an amending status of said file data; and
receiving said processing signal by means of said file filter, handling said processing signal according to criteria of said file filter so as to decide whether said file data should be written in said storage unit or not.

15. The file management method of claim 14, wherein said criteria comprise an expiration date such that said file data will be deleted after the expiration date.

16. The file management method of claim 14, wherein said criteria comprise a capacity limit to delete said file data when said storage unit is under the capacity limit.

17. The file management method of claim 14, wherein said criteria comprise file categories so as to decide whether said file data should be written or not according to file name extensions.

18. The file management method of claim 17, wherein said file categories are selected from a group consisting of temporary files, trash mails and a combination thereof.

19. The file management method of claim 14, wherein said storage unit is selected from a group consisting of floppy disks, hard disk drives, redundant array of independent disks, random access memory, non-volatile memory, rewritable optical discs and combinations thereof.
